(19) United States
(12) Patent Application Publication
(10) Pub. No.: US 2021/0348050 A1
(43) Pub. Date: Nov. 11, 2021

(54) Chemical Additives for Enhancing the Performance of Friction Reducer Solution and its Applications Thereof

(71) Applicants: Feipeng Liu, Spring, TX (US); Yuning lai, Spring, TX (US)

(72) Inventors: Feipeng Liu, Spring, TX (US); Yuning lai, Spring, TX (US)

(73) Assignee: Genesis Materials Innovations, LLC, Spring, TX (US)

(21) Appl. No.: 17/191,380

(22) Filed: Mar. 3, 2021

Related U.S. Application Data
(63) Continuation of application No. 16/600,444, filed on Oct. 11, 2019.

(51) Int. Cl. C09K 8/68; C09K 8/66; C09K 8/035; C09K 8/70

(52) U.S. Cl. CPC C09K 8/685; C09K 8/706; C09K 8/035; C09K 8/665

(57) ABSTRACT

Chemical additives useful for hydraulic fracturing operation are comprising of lubricant/nonpolar solvents; hydro-dual-phobic domains as core encapsulated by emulsifiers as shell, suspended in water by hydrogel polymers as hydrophilic domains; soy protein isolate (SPI) and sweet rice flour were modified with crosslinking polymers of isocyanate as hydrophobic domains, which is incorporated into the frac fluid as a standard alone friction reducer solution or as an enhancer of frac fluid viscosity of the final frac fluid products in high salinity brines having a concentration as high as 25.0% at an ambient temperature at a downhole well temperature from 30 to 180° F.

### FIELD OF INVENTION

This invention is related to frac fluid additives used for enhancing the frac fluid viscosity in the high salinity brine environments, by which the fresh or/and produced water or waste water stream can be blended together with the disclosed chemical additives or/and independently used as frac fluid solution for transporting proppants and other chemicals downhole at reduced cost and enhanced transportation efficiency in the hydraulic fracturing operation of the subterraneous formation for hydrocarbon resource extraction.

### BACKGROUND OF THE INVENTION

Hydraulic fracturing operation is a well-known method of stimulating the production of hydrocarbon bearing formations, in which the injected fluid is brought into the wellbore at a high pressure mixed with proppant, water, and other small percentage of functional chemicals. The processes include pumping the fracturing fluid from the well surface through a tubular that has been prepositioned in the wellbore to access chemicals and aid in proppant, friction reducer, wettability, and pH control chemicals to the cracks or fissures in the hydrocarbon formation. Without a significant reduction of pumping pressure to the fluid system, fracking operation would have been impossible due to the high pressure pumping cost and technical requirements.

Hydrolyzed polyacrylate sodium acrylamide polymers and other similar polymer materials used in hydraulic fracturing operation are key components for reducing the pumping pressure and extracting hydrocarbon in term of oil and gas energy exploration, in which the acrylate sodium polyacrylamide polymers are dispersed in water or other fracturing fluid to make the frac fluid slippery. Meanwhile, the frac fluid systems demand that proppants, such as frac sand, ceramics proppants, bauxite, or/and resin coated proppant's materials, are suspended with a viscosity of frac fluid through partially or totally cross-linking the polymeric materials during the transportation of the proppants from the top surface to the bottom hole wellbore and further down the rock cracks and fissures. The dosage level of hydrolyzed polyacrylate sodium acrylamide polymers added in the wells is, in general, ranged between 0.20 to 5.0 Gallon per thousand (gpt) gallons of liquid water solutions.

Most widely used friction reducer (FR) chemicals are polyanionic polymers, however, one drawback of this type of FR chemicals is that as much as 90-95% of original viscosity of the original FR solution will be lost as cationic ions in water solvent, such as sodium chloride (NaCl), calcium chloride, magnesium chlorides, and ferric chloride, are added into the frac fluid solution. These cationic ions are needed for inhibiting the swelling of fractured rocks in completion operation. Also, they are widely dissolved in the flowback water or well water containing high percentage cationic ions after recycling these waters, called “produced water” which includes water from the processes of lifting oil and gas from water bearing formations; typically, ancient sea or lake, which contains subset or mixture of dissolved produced water. Salinity often ranges from 100 (mg/l) to 400, 000 (mg/l). Dissolved organic oils are often mixed in the produced water. The large quantities of frac fluid are required in the fracking operation, high cost of produced water transportation and disposal, high cost of fresh water, and limited fresh water resource, and environmental concern make the utilization of produced water from recycled process or nearly wells become a preferred choice in the fracking operation.

For example, salinity water concentration of sodium chloride as high as 25.0% has been reported in North Dakota oil field. For every barrel of oil produced through fracking, half barrel of water is generated as waste stream that must conduct post disposal. Solutions for utilizing the produced water depend on locations, geology, and technology. Currently, an injection of the produced water into the unused wells is a simple and effective method of mitigating waste water stream. Since hydraulic fracking operation needs water, if source water or fresh water is expensive or not available, produced water offers a good option to keep it and make it reusable. Then, there is a need to prepare treatment fluids with produced water or other environmental water sources, which has adequate viscosity and such need is met at least in part by utilizing produced water coming from lifting oil and gas plus special chemical additives or viscosity enhancers that promote the viscosity of frac fluid blended with produced water besides the fresh water.

In addition, traditional synthetic polymers such as partially hydrolyzed polyacrylamide (H PAM) are not thermally stable. At temperatures higher than 60° C., acrylamide moieties hydrolyze rapidly in sodium acrylate, leading to precipitation and a total loss of viscosifying power. A treatment on these waste stream of the recycled water containing degraded polyacrylate and acrylamide polymer segments and mineral cationic elements often presents many challenges due to the chemical complexity of the water affecting the fluid's ability to achieve adequate viscosity.

Methods for enhancing the high salty frac fluid viscosity and high heat resistant frac fluid have been developed in the industries. For example, thermal stability can be improved by incorporating more expensive monomers such as ATBS or NVP functional groups in regular polyacrylate sodium acrylamide polymers (Rodriguez et al. 2019).

Alternatively, a polymer with polyol group as a key component in the blended ATBS and NVP emulsion of the polymers could be used to enhance the hydrated viscosity of blended frac fluid chemicals (Sarkis and Robert 2017). Thermo-viscosifying polymers were successfully used to pump a salt-induced viscosity enhancement in the case of inter-saturated shale oil reservoirs (Li, et al. 2019), however, there is still a need for a cost-effective additive recipe to enhance the viscosity of high salinity recipes that can use not only fresh but also produced water containing high salinity brines. The applicants believe that the disclosed formulation and recipes provide a cost-effective technical approach for enhancing the viscosity of friction reducer solution that can partially and totally replace the polyanionic polymers used as friction reducer chemicals, especially, the recipe is an excellent candidate for its application as friction fluids in high salinity brine environments.

### BRIEF DESCRIPTION OF THE DRAWINGS AND FIGURES

Embodiments in according with the present invention are described below with reference to the following accompany figures and/or images that are specified portions of various embodiments of this invention and provided for illustrative purpose only.

FIG. 1. Schematics of proposed emulsion and coatings with SPI and wax as the core layer and emulsifiers as the shell layer. Hydrogel polymers as partially gelling; 101—organic lubricant/solvent; 102—solid particles as micro-nanotextured materials; 103—emulsifier agent; 104—polar solvent (water); 105—antimicrobial agents; cross-linking agents.

FIG. 2. Schematics of the interaction of emulsified micelles with a fracking fluid containing friction reducer polymer (107) and concentrated sodium chloride and other potential cationic ions as brine solution (108).

FIG. 3. Plot of measured Brookfield viscosity of blended friction reducer (FR) solution under the different salt concentration: a) Vis1: the viscosity of fracking fluid as a function of salt concentration at a friction reducer (FR) solution concentration of 0.15% and shear rate of 525 (1/s); b) Vis2: at FR solution of 0.50% at a shearing rate of 525 (1/s); c) Vis3: at FR solution of 0.15% and shearing rate of 1050 (1/s); d) Vis4: at a FR solution concentration of 0.50% and a shearing rate of 1050 (1/s).

FIG. 4. Plot of measured Brookfield viscosity of the blended examples 13 and 6 chemical additives vs. the base recipe of 2-54-1 from example 14 at a selected measured shearing rate (SR) of 525 (1/s) and 1050 (1/s).

FIG. 5. Plot of measured Brookfield viscosity as a function of salt concentration under different conditions: Both of examples 28 and 39 were blended at a ratio of 30% with tap water plus salt in powder prepared at different salt concentration at different solution temperature.

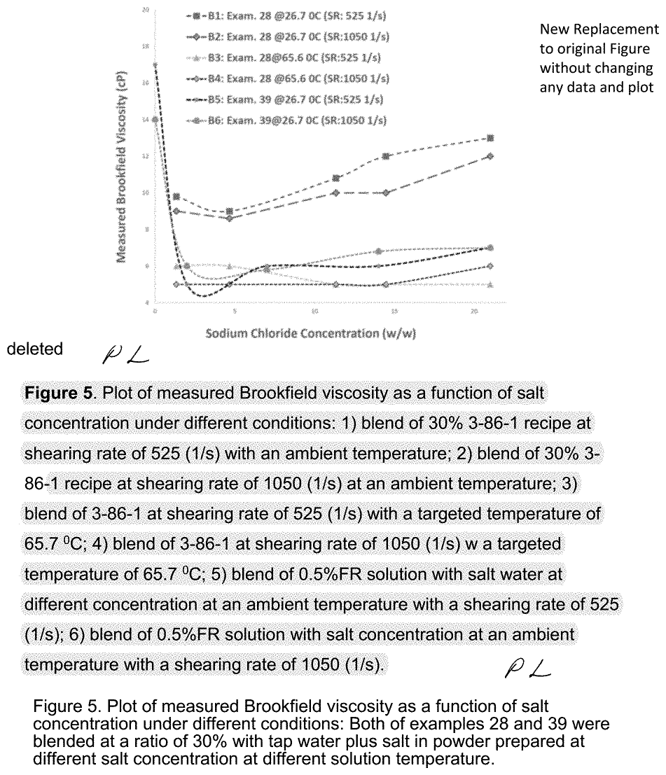

FIG. 6. Plot of measured Brookfield viscosity of chemical additives prepared with the recipe described in example 50 blended into the tap water plus salt in powder determined at selected shearing rate of 525 (1/s) and 1050 (1/s) and solution temperature of 26.7° C. and 65.6° C.

### BRIEF DESCRIPTION OF THE INVENTION

In this disclosed invention, the chemical additives are comprising of the following components by percentage weight (% Wt.):

a) mineral oil or other hydrophobic solvent in a range from 1.0% to 99.0%;

b) paraffin wax or/and reactive wax, soy protein isolate (SPI) and sweet rice or other biopolymer materials and the combination of these products as hydro-dual-phobic domain materials in a range from 0.10% to 30.0%;

c) emulsifier or non-ionic surfactants as encapsulated shell or control release agent in a range from 0.001% to 20%;

d) hydrogel polymers as suspending agents in a range of 0.00% to 35% in liquid, powder, or their combination;

e) fresh water or/and recycled produced water as solvents for reaction and viscosity adjustment in a range from 40.0 to 99.0%;

f) a combination of (a)+(b)+(c)+(d)+(e) or a pre-polymerization of (a)+(b)+(d) following an addition of (c) and (e) as chemical additives in hydraulic fracking operation to enhance the viscosity of the frac fluid in a concentrated salinity environments up to salty saturation points of 26.5% at an ambient temperature of 25° C. or so.

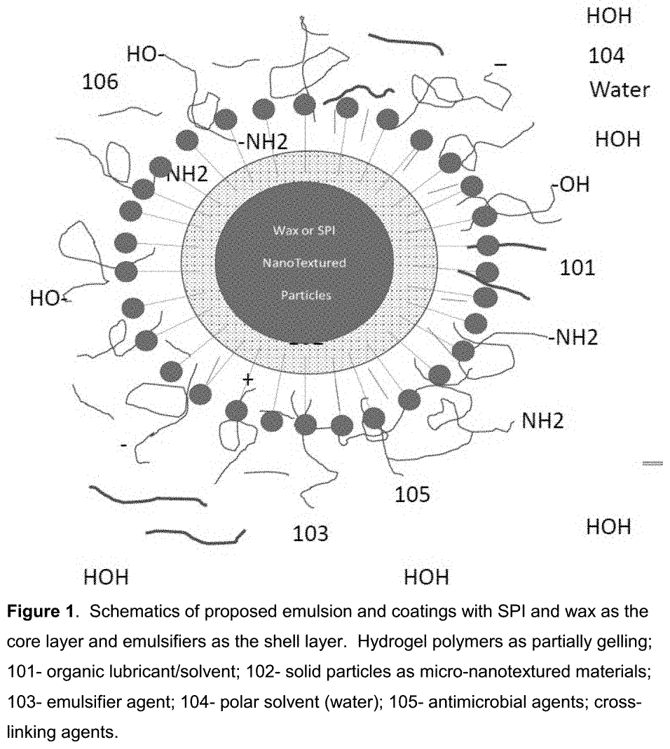

Procedures of preparing the above chemical additives for enhancing fracking fluid's viscosity include that an addition of the mineral oil (a long chain straight hydrocarbon) into a container, then, soy protein isolate (SPI) or soy flour, or/and paraffin wax are charged into the container, then, a modifier agent for SPI surface functional modification, for example, grafting functional groups of aldehyde, isocyanate, or amine, and amide groups on the surface of SPI. Alternatively, the hydrogel polymers in powder form, could also be potentially modified on the surface of SPI particles, then, the temperature of solution mixture is increased to 140° F. or so, to accelerate the reaction rate of the mixed components in the mineral oil solvent, then, the mixed components are charged with emulsifier or surfactant agents. Finally, the hydrogel polymers are charged to suspend the encapsulated particles in solution. Water as a solvent allows the mixed components dispersed in solution with desirable particles as the additive coating is cooled down to an ambient temperature. As shown in FIG. 1, the structure of the chemical additives and/or emulsion coating is schematically illustrated.

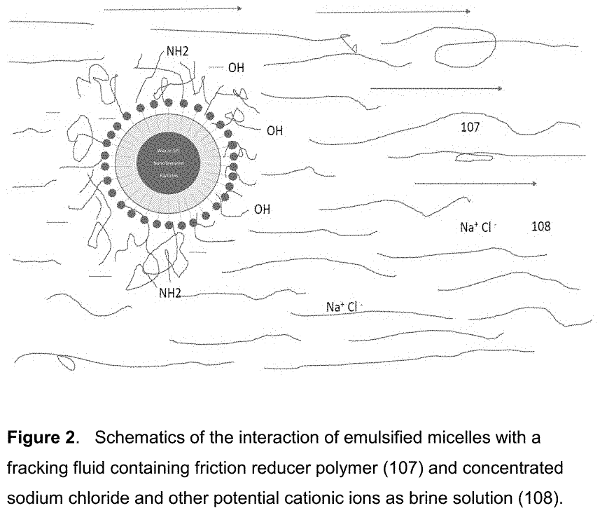

The mixed components from the formulated recipes are adjusted on their solid content, pending upon the application requests for the solution viscosity through adjusting the water content in the recipe. As a result, the final products can be applied by blending the developed additive product with produced water in a ratio by wt/wt from 30% to 100% to enhance the viscosity of the final fluid products disclosed here, pending upon the salt content of fresh or produced water. A schematic interaction mechanism of produced water with disclosed emulsion particles is illustrated in FIG. 2.

Although the mechanisms of increased viscosity of mixed components are not clearly understood, it was discovered that the disclosed formulation and recipes could increase the viscosity of the blended products with regular FR solution at an ambient temperature and increase the salty introduced viscosity of the mixed chemical additives up to the solution temperature of 160° F. Thermo-thickening of the formulated friction reducer (FR) phenomena was observed, potentially due to the introduced hydrophobic and hydrophilic dual functional domains on the SPI or wax paraffin surface served as connected dots and chains with physical entanglements instead of chemical cross-linking and branching variations.

The disclosed invention and art of practices do not mean any limitation and optimized conditions to the invented embodiments, it is only served as a demonstration to the art of practice. Detailed description of the invention will be shown subsequently

### DETAILED DESCRIPTION OF THE INVENTION

Hydraulic fracturing has been an important technology advance in the extraction of natural gas and petroleum oil, but, the produced waste water or water that is produced along with shale gas and petroleum following fracking, is extremely saline and contains largely high concentration of barium, waste water from basin to basin, oil and gas as production booms. Waste water, called produced water containing high salinity, toxicity, heavy metal, and chemicals, is injected back into the ground. For everyone barrel of oil—about 45 gallons per barrel produced water produced in the fracking operation based upon a statistical study in 2014. Recycled use of these water is the most expensive option. In North Dakota, the produced water can have salinity as high as 25(%) w/w. Injection of the water into abounded wells has been a simple and most effective method of mitigating the environmental impact.

As less and less injection wells are available for dumping the produced water, price for disposing these waste water and recycling of these water resource has been sky-rockets from USD: 0.5 gallons to USD: 3.00+/bbl. Treatment of the water and reuse and pumping it back to fracking well become very attractive to the industries in term of environmental concerns and cost saving on produced water. The quality of produced water varies a lot that can be classified into three categories based upon the specification of total dissolved solids (TDS):
Brackish: 5000 to 35,000 (mg/L)
Saline: 35,000 to 50,000 (mg/L)
Brine: 50,000 to 150,000 (mg/L)

In general, the viscosity of frac fluid used in fracking operation is required to be ranged from 50 to 1000 (cP) at a nominal shear rate from 40 to 100 (1/s). Operationally, it requires that the flow rate of frac fluid is ranged from 60 to 100 (bbl/minute). For sea water used for fracking, there are about 3.5% of NaCl solid dissolved in the water that its TDS can be up to 350,000 (mg/L).

As described in previous section, the applicants have discovered addition of the described composites in combination with saline water and low concentration of hydrolyzed polyanionic polymers can be effective in increasing the viscosity of the saline water, potentially used for produced water utilization for fracking operation. By increasing the viscosity of the produced water/recycled water in such a way, a subterranean formation treatment fluid, such as a fracturing fluid, may be prepared at the surface and pumped into a wellbore at a pressure enough to treat a target zone in the formation. In some perspective, a crosslinker, and optional viscosifying polymer, could be added to form a complexed multifunctional additive. Such system could be functioned in both low and high temperature, low, and high salinity environments.

As a matter of fact, chemical additive components, comprising of soy protein isolate or wax or the combination of soy protein isolate and paraffin wax, can be considered as hydrophobic/hydrophilic microdomains or hydro-dual-phobic domains. Hydrogel polymers as hydrophilic domains, and mineral oil as organic solvents/lubricants, and water as solvent media, and emulsifier as intermediate shell face materials, a modification through grafting and crosslinking reactions will be able to effectively enhance the viscosity of regular friction reducer's performance. Potentially, the encapsulated domains in the emulsion can be used to mediate the viscosity of blended fluid due to the cross-linked structure and hydro-dual-phobic domains. The developed formulation recipe was discovered to have excellent salt tolerance and high temperature resistance for enhancing and maintaining the viscosity of the blended components as described in detail in the following section.

Lubricant and Organic Solvent: The synthesis processes of the hydrolyzed polyacrylate sodium acrylamide (HPAM) polymers are involved in an inverted emulsion. Mineral oil or saturated hydrocarbon (Kerosene) is, in general, used as a key solvent for preparing the HPAM friction reducer emulsion. As a result, HPAM hydrogel polymer is dispersible in the lubricants. It was found that the mineral oil will be an excellent solvent and left as a key component in the final products instead of distilled out from the coatings due to its hydrophobicity as an inertia liquid. Lubricants or oils are comprising of the derivatives from petroleum crude oil, containing saturated hydrocarbon and alkyl group from C6 to C25. Alternatively, the lubricants can also be originated from the bio-derivative resource such as corn, soy bean, sunflower, linseed oil containing long chain alkyl components. The lubricants can also be synthetic oil chemicals made of reactive ester or hydroxyl functional alkyl chains or saturated hydrocarbons coupled with silane coupling agent or having silicon functional groups. The dosage level applied in the chemical compositions for lubricants is added in a range from 1.0% to 99%. A typical mineral oil that can be used is a white mineral oil labelled as 70 Crystal Plus white mineral oils, manufactured by STE Oil company, TX, USA. It is a series of derivatives of petroleum crude oils. Alternatively, soy bean oil and linseed oil, or synthesis silicon oil can be used as lubricants. Other examples of lubricants include ethylene bisstearic acid, amide, oxy stearic acid, amide, stearic acid, stearic acid coupling agents, such as an amino-silane type, an epoxy-silane type and a vinyl silane type and a titanate coupling agents.

Micro/Nanotextured Porous Domains for Enhanced Viscosity: Of the disclosed chemical composition and emulsion coatings as shown in FIG. 1, randomly distributed micro/nanotextured domains can be created by incorporating powder materials on the coating surface. More specifically, the surface of bio-polymer particles such as soy protein isolate (SPI) or/and sweet rice flour can be grafted with isocyanate polymers or other functional cross-linking agents to achieve desirable hydrophobic or hydrophilic domains differently from the peptide molecular structure of soy protein isolate (SPI). Alternatively, hydrogel polymer of HPAM in powder form (90% to 95% oven-dried) can be copolymerized with soy protein isolate (SPI), soy flour, and denatured soy protein, together to obtain a hydro-dual phobic domain material. That is, both of SPI and HPAM in powder as particles or granular particles are chemically cross-linked together. The applicants believe that the copolymers from the SPI and HPAM chemical reaction through functional group of polyurethane and amide are unique that the viscosity of the mixed components are potentially enhanced as mixed components are added into the solutions due to the introduced multifunctional reactive sites on the surface of HPAM polymers.

Another benefit of utilizing the SPI is that the SPI is in a porous network structure. Potentially, the hydroxyl, amide, and amine functional groups located on the surface or inside of the SPI particles are easily interacted with each other to physically generate the hydrogen and ion bonds among the HPAM and SPI gel particles, leading to an enhanced viscosity of the mixed components.

Since SPI is made from de-fatted soy bean flakes that have been washed in either alcohol or water to remove sugars and dietary fibers, a typical SPI nutrient component in 1-once plain powder based upon a USDA national nutrient database release (2004) has a component as total fat: 2(%); saturated fat: 0(%); total carbohydrates: 1(%); protein: 46(%); cholesterol: 0(%); sodium: 12(%); dietary fiber: 6.0(%); calcium 5(%); potassium: 1.0(%); phosphorus: 22.0(%); folate: 13(%). Major components of soy protein isolate (SPI) are made of soy bean products, which is abundant, inexpensive, renewable, biodegradable, and nontoxic. This provides extensive resource as frac fluid additives. A literature review on SPI manufacturing, its structure, applications, and market potentials has been reported previously (Markley K. S. 1950 and 1951, Nishinari, et. al. 2014). Less costly, soy protein concentrates, containing 70% of proteins from denatured soy beans, can be used for reacting with other components as replacement of soy protein isolates. There are three major methods for extracting the soy components in a selected manner without solubilizing the major protein fractions.
The aqueous proteins
The acid processes
Heat denaturation/water wash method

All three types have basically the following proximate composition, on a moisture free basis: protein (Nx 6.25) 70%; insoluble carbohydrates 20%; ash: 5-8%; lipids: 1.0%¹. ¹ http://www.89 Soya Bluebook, Fao.org

Through denaturation, soy bean is isolated, containing primary amine (—NH₂—), secondary amine (—NH—), and acid carboxylic functional group (—COOH—). These functional groups provide extensive networking connection joint points with polyamide I and II bonds (Parker 2010). In one perspective, the disclosed recipe provides a chemical composition comprising SPI+polymers or pre-polymer's blends from 0 to 90(%) of a reactive polymer selected from the group consisting of an organic isocyanate, a polyol, a polypeptide or oxide epoxy resin. The dose level of polypeptides is ranged from about 10.0% to 99% (wt./wt.).

The organic polyisocyanate can be selected from the group consisting of polymeric diphenylmethyl, diisocyanate (p_MDI), 2., 4-methylene diphenyl diisocyanate. Under certain conditions, these poly-isocyanate polymers have one or two or tri-functional reactive groups reacted with the polypeptide bonds originated from SPI. The terms “protein” and “polypeptide” are used synonymously and refer to polymers containing amino acids that are jointed together.

For example, peptide bonds or other bonds may contain naturally occurring amino acids or modified amino acids. The polypeptides can be isolated from natural sources or synthesized using standard chemistries or by chemical modification technology, including cyclization, disulfide, demethylation, deamination formation of covalent cross-links, formation of pyroglutamate, formylation, gamma-carboxylation, glycosylation. The term “isolated” refers to material that is removed from its natural environment if it is naturally occurring.

Potential bonds between and among the SPI and isocyanate might include the amide and carboxylic ester, and imide bonds after cross-lining of SPI and isocyanate. Potentially, the HPAM can be incorporated into the SPI molecular chains and network structure through the multi-component's reactions. The applicants believe that the increased viscosity of modified HPAM with SPI crosslinked with isocyanate or epoxy polymers are potentially originated from the attribution of SPI's salt tolerance attribution due to the SPI's strong bonds with cationic ions such as sodium, calcium, and magnesium, and ferric chloride.

In comparison of polypeptide bonds vs. other chemical bonds, the polypeptides are very strong so that they can resist the heating temperature as high as 130° C. in the processing of denature and defat soy bean materials, unfortunately, none of study of chemically grafting SPI moieties on the HPAM polymers have been conducted, not mentioned how the grafted SPI/HPMA polymer micelles will affect the performance of frac fluid solution.

Procedures for generating a core layer as shown in FIG. 1 are involved in first charging the lubricants such as mineral oil into a reactive tanker. Subsequently, SPI and/or and HPAM can be added into the tanker or container. Then, crosslinking agent of p-MDI will be added into the reactor. Heating the mixed components in a reactor allows the solvents/lubricants to reflux in the condenser within a defined time (say at least 5 minutes at 60° C.). Besides the functional group of isocyanate (—NCO) from p-MDI, other crosslinking agent such as oxide epoxy, amine, aldehyde, carboxylic acid, silane coupling agents can be used to modify the SPI surface or crosslink the SPI with HPAM. The blended or reacted SPI-HPAM and isocyanate/lubricant system serves as the core layer of emulsion in the emulsion structural design. Then, the core layers that have the excellent power of enhancing the viscosity of frac fluid were encapsulated with emulsifiers in the 1^{st} phase polymerization of mineral oil. The reaction temperature can be as low as ambient; however, preferred reaction temperature can be as high as 130° C. or less, preferred at 60° C. or less. After the p-MDI is fully reacted with SPI or HPAM, shell layer materials such as emulsifiers can be added in the mixed components and optimized further.

Emulsifier/Surfactants as Emulsion Shell Materials: An emulsifier is a surfactant chemical. It can be cationic, anionic, nonionic, zwitterionic, amphiphilic having linear long chain, branched with di-functional, tri-functional or multi-functional star's structures, consisting of a water-loving hydrophilic head and an oil-loving hydrophobic tail. The hydrophilic head is directed to the aqueous phase and the hydrophobic tail to the oil phase. The emulsifier positions itself at the oil/water or air/water interface and, by reducing the surface tension, has a stabilizing effect on the emulsion. In addition to their ability to form an emulsion, it can interact with other components and ingredients. In this way, various functionalities can be obtained, for examples, interaction with proteins or carbohydrates to generate connected clusters both chemically and physically.

Typical emulsifiers include stearic acid oxide ethylene ester, sorbitol fatty acid ester, glyceryl stearate acid ester, octadecanoic acid ester, combination of these esters, fatty amine, acid chemical additives and compounds, alkylphenol ethoxylates such as Dow Tergitol NP series of surfactants, glycol-mono-dodecyl ether, ethylated amines and fatty acid amides. For examples, SPAN 60: polysorbitan 60 (MS) and PEG100 glyceryl stearate MS are two typical emulsifiers used in cosmetics industries. Typical emulsifiers are branched as polyoxide-ethylene parts, groups found in the molecules such as monolaurate 20, monopaimitate 40, monostearate 80, etc. with HLB from 4.0 to 20.0, preferred from 10 to 17.0.

Dosage level of added emulsifiers in the emulsion can be ranged within 0.01% to 5.0%, more specially less than 3.0% (Wt/wt). The emulsifiers are water insoluble or only partially water soluble, and dispersible. It is only dissolved in hot water. SPI and wax or other polyhydroxyl compound's materials such as sweet rice flour can be included as core materials in the micelle structure. In contrast, the emulsifiers can only be used as shell materials in the micelle structure.

The emulsifiers in the disclosed additives are critical components. It has its hydrophilic heads toward the outside water loving phase and create strong interaction with water solvent. Meanwhile, it has its hydroph hydrophobic long chain tail portion toward the waxy or SPI sphere as core materials for the micelle. SPI sphere or SPI-isocyanate-HPAM particles are potentially sealed into the micelles. In addition, the amide and amine from the HPAM and SPI might be critical for enhancing the viscosity of the mixed components although the reaction mechanisms might not be understood. The applicants believe that the interaction among these chemicals makes the chemical additives blended into the produced water or fresh water very complicated with unprecedent unknown attributes.

Cross-linking Agent: To enhance the stiffness of the core layer or shell layer of the micelles, selected cross-linking agent can be used to reinforce the micelle and hydrogel polymer structure. Preferred cross-linking reaction schemes were discussed in the previous section with p-MDI isocyanate functional resin polymer as an example. The purpose of p-MDI reaction with SPI is to enhance the hydrophobicity of SPI, potentially with extended hydrophobic chains to enhance the internal friction of the fluid molecules, leading to an increased viscosity of the frac fluid. A typical polymer, such as isocyanate or unsaturated polyurethane (PUR) agents, could be used as cross-linking agent. Alternatively, reaction of crosslinked agents can be chemically cross-linked with non-reversible connections in nature or reversible with hydrogen bonding, pending upon the blended component's condition. Alternatively, chemicals, containing epoxy, amine, amide or reactive aldehyde, hexamine, and hydroxy-amine functional groups of polymers can also be used. The preferred dosage level of cross-linking agents of the whole recipes should be less than 10% (wt/wt), preferred less than 5.0% (wt.).

Antimicrobial Agent: Since soy protein isolate (SPI) and sweet rice flour are bio-derivatives materials, these materials tend to decompose themselves in the ambient condition. Microbial and fungus might potentially grow if these materials are used in water-based recipes during storage or transportation. Therefore, antimicrobial agent is needed in the recipe, preventing bio-materials from bacteria or micro-fermentation. Common preservative additives include glutaraldehyde, formaldehyde, hexamine, benzyl ammonium chloride, methylisothiazolinone, 2-phenoxy ethanol, copper sulfate, copper oxide nano powder, fatty amine, etc. Dosage level of the added antimicrobial agents are ranged with 1.0% (wt/wt) or preferred less than 0.1%.

Hydrogel Polymer: To help the suspension of proppants in frac fluid as the fluid carries the proppants downhole to the wellbore, it is common to use a viscosity increasing agent for increasing the viscosities of fresh water or produced water. Common practices in current technologies disclosed are to use hydrogel polymers such as hydrolyzed polyacrylate sodium acrylamide polymers. The preferred dosage level used with HPAM as friction reducer in frac fluid is ranged from 0.2 to 2.0 gallons of friction reducer per 1000 gallons of water (gpt). The hydrated viscosity of frac fluid is around 3.0 to 15 (cPs).

As shown in FIG. 2, the hydrogel polymers can serve as a suspending polymer aligned in the frac fluid as it flows through the tubular pipeline during hydraulic fracking operation. Cationic ions, such as sodium chloride, calcium chloride, magnesium chloride, ferric chloride, are typical cationic ions in the fresh water or produced water in the bearing formation. These cationic ions, in general, affect the fluid viscosity negatively. The loss of viscosity can be as high as 70 to 95% due to the precipitation of polyacrylate or acrylamide polymers from the interaction of charged cations of these ions. In the disclosed recipes, small quantities of HPAM was used as a primary suspending agent for the suspension of emulsion in the water phase. As a result, for fresh water and less salinity water, less dosage level is needed to use the developed formula. Otherwise, more dosage level with the developed recipe is needed to enhance the viscosity of developed frac fluid.

To enhance the suspending capabilities of HPAM, low cost sweet rice flour could be blended with the HPAM. Sweet rice flour, consisting of hemi-cellulosic materials and vegetable protein contained in it, belongs to the chemicals of poly-sugars with extended hydroxyl functional groups in its backbone chains. An interaction of sweet rice flour is believed to promote the increased viscosity of mixing HPAM as hydrophilic domain's additions with sweet rice components.

Water: Water is a key component as medium and dilute agent in preparing the chemical additives as the viscosity enhancer of the fluid in the hydraulic fracking operation. There exists a various water resource for hydraulic fracturing operation as described previously. Certainly, the best water without affecting friction reducer's chemical effectiveness is fresh water, unfortunately, in some area or shale plays, often, produced water is only cost-effective water resource. Technologies leading to reuse these produced waters are needed. It was reported that in North Dakota shale plays, there exists some high salinity wells. The salinity of inter-play can be as high as more than 26.0% at its saturation of salts under the downhole conditions. Dosage level of water added should be given a consideration on what is required case by case. Preferred percentage of wt. by wt. should be ranged within 40% to 99%, preferred 85% to 95%.

The regular HPAM polymers failed to provide the needed suspending and drag reducing capabilities to the frac fluid. It was discovered in this disclosed recipe that the viscosity of invented chemical fluid additives was significantly increased by as much as 50% with an increased salinity of the brine solution up to the 25.0%. The well temperature of the applied chemical additives as viscosity enhancer can be as high as 160° F. in the case of SPI copolymerized with isocyanate. Also, it was discovered that as paraffin wax was used as key components as viscosity enhancer, as much as 15 to 20% friction reducer solution can be saved while still maintains the FR solution best performance in the case of high salty brine fracking environments.

Procedures for preparing the chemical additives solution disclosed herein include: 1) add the mineral oil, SPI or/and wax, and/or partial or fully HPAM into a tanker or mixer; 2) stir the mixed components; 3) heat the mixed components in the tanker/container or preferred in a reflux flask or reactor with a condenser that controls the reactor's temperature until the temperature reached to 140° F. or above; 4) charge emulsifiers and sweet rice flour or others; 5) add the HPAM while the mixed components in the mixing processing; 6) charge the cooling water (½); 7) charge the other half of cooling water; and 8) cool down the whole mixture to ambient temperature before turning off the blending processes; 9) Transfer the completed additives into totes or stored in designated containers, and 10) conduct all needed quality control test before releasing for sale. 11) The products can be independently used as frac fluid FR solution or viscosity enhancer blended with other FR solution with produced water in oil field site applications. Various advantages of the disclosed formulation and recipes are going to be illustrated in the explanatory examples of 1 to 70.

### EXPLANATORY EXAMPLES

Example 1: To a 1000.0 mL of beaker, charged 597 (g) of water, then, stir the mixture under magnetic stir bar; 3.076 (gram) of LB 206, a hydrolyzed polyacrylate sodium acrylamide (HPAM) solution, was added into the beaker when the water solution is still under stirring rotation with vertex in the beaker. The viscosity of the prepared samples was measured with a Brookfield viscosity meter. Its measured viscosity is as follows: a) 424 (cPc) at RPM of rotary speed of 6 (RPM); 277.0 (cPc) 12 (RPM); 157 (cP) at 30 (RPM); and 100 (cPc) at 60 (RPM). The samples were labelled as 3-93-1, then, 210 (gram) of water was blended with 90 (gram) of 3-93-1 to make a solution of 0.15% FR friction reducer frac fluid. The measured viscosity of 0.15% FR without a salt in the solution was determined by Brookfield viscometer. The results are listed in Table 1, the sample ID was labelled as 3-95-1.

Example 2. To a 500 (mL) of beaker, 6 (gram) of Morton salt solids was added into the beaker, then, charged more water until the scale reading of 210 (g). Then, about 90.0 (gram) of 3-93-1 sample was charged into the beaker. The Brookfield viscosity of the samples was determined @ an ambient temperature of 80° F. after the mixed components were blended together. The results are listed in Table 1 labelled with the sample ID of 3-93-2.

Example 3. To a 500 (mL) of beaker, 21 (gram) of Morton salt solids was added into the beaker, then, charged more water until the scale reading of 210 (g), then, about 90.0 (gram) of 3-93-1 sample was charged into the beaker. The Brookfield viscosity of the samples was determined after the mixed components were blended together at an ambient temperature of 80° F. The results are listed in Table 1 labelled with the sample ID of 3-94-1.

Example 4. To a 500 (mL) of beaker, 42 (gram) of Morton salt solids was added into the beaker, then, charged more water until the scale reading of 210 (g), then, about 90.0 (gram) of 3-93-1 sample was charged into the beaker. The Brookfield viscosity of the samples was determined after the mixed components were blended together. The results are listed in Table 1 labelled with the sample ID of 3-94-2.

Example 5. To a 500 (mL) of beaker, 63 (gram) of Morton salt solids was added into the beaker, then, charged more water until the scale reading of 210 (g), then, about 90.0 (gram) of 3-93-1 sample was charged into the beaker. The Brookfield viscosity of the samples was determined after the mixed components were blended together. The results are listed in Table 1 labelled with the sample ID of 3-94-3.

Example 6. To a 1000 (mL) of beaker, charged 1000 (mL) of water and stir the water with magnetic stir bar, then, about 5.0 (gram) of LB 206, a hydrolyzed polyacrylate sodium acrylamide (HPAM) commercially available, was charged into the beaker drop wisely to disperse the LB206 uniformly. The Brookfield viscosity of the samples was determined after the mixed components were blended together. The results are listed in Table 1 labelled with the sample ID of 3-113-1. The prepared FR solution concentration is 0.5% w/w or appropriately about 5.0 (gpt).

Example 7. To a 500 (mL) of beaker, 6 (gram) of Morton salt solids was added into the beaker, then, charged the 3-113-1 sample until get the total wt. of 300 (gram) was charged into the beaker. The Brookfield viscosity of the samples was determined after the mixed components were blended together. The results are listed in Table 1 labelled with the sample ID of 3-114-1.

Example 8. To a 500 (mL) of beaker, 15 (gram) of Morton salt solids was added into the beaker, then, charged the 3-113-1 sample until get the total wt. of 300 (gram) was charged into the beaker. The Brookfield viscosity of the samples was determined after the mixed components were blended together. The results are listed in Table 1 labelled with the sample ID of 3-114-2.

Example 9. To a 500 (mL) of beaker, 24 (gram) of Morton salt solids was added into the beaker, then, charged the 3-113-1 sample until get the total wt. of 300 (gram) was charged into the beaker. The Brookfield viscosity of the samples was determined after the mixed components were blended together. The results are listed in Table 1 labelled with the sample ID of 3-114-3.

Example 10. To a 500 (mL) of beaker, 42 (gram) of Morton salt solids was added into the beaker, then, charged the 3-113-1 sample until get the total wt. of 300 (gram) was charged into the beaker. The Brookfield viscosity of the samples was determined after the mixed components were blended together. The results are listed in Table 1 labelled with the sample ID of 3-115-1.

Example 11. To a 500 (mL) of beaker, 60 (gram) of Morton salt solids was added into the beaker, then, charged the 3-113-1 sample until get the total wt. of 300 (gram) was charged into the beaker. The Brookfield viscosity of the samples was determined after the mixed components were blended together. The results are listed in Table 1 labelled with the sample ID of 3-115-2.

Example 12. To a 500 (mL) of beaker, 75 (gram) of Morton salt solids was added into the beaker, then, charged the 3-113-1 sample until get the total wt. of 300 (gram) was charged into the beaker. The Brookfield viscosity of the samples was determined after the mixed components were blended together. The results are listed in Table 1 labelled with the sample ID of 3-115-3.

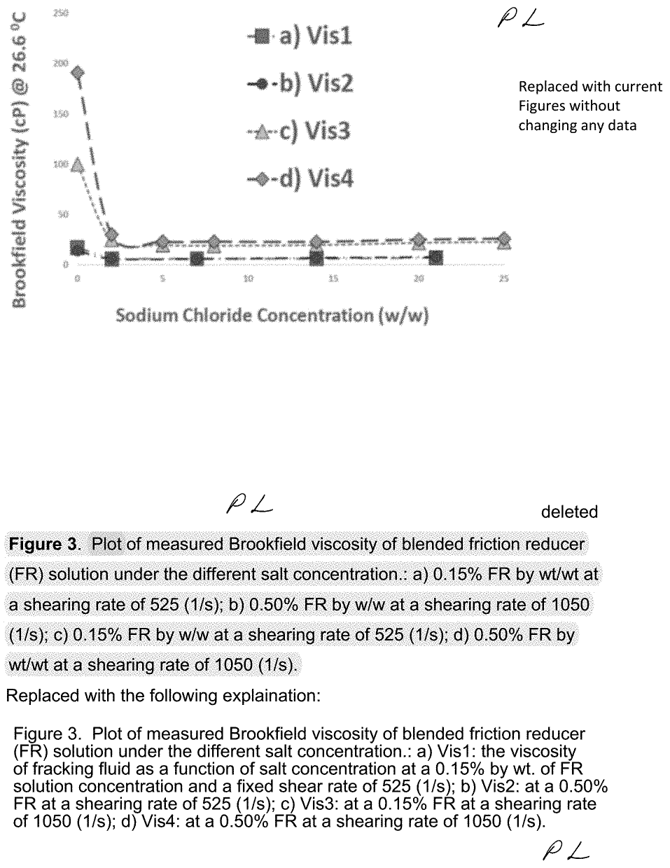

All viscosity measurements were conducted at an ambient temperature of 80° F. (or 26.6° C.). Table 1 listed the results and corresponding condition for the blended materials. A plot of the measured Brookfield viscosity as a function of salt concentration is also shown in FIG. 3.

TABLE 1
Measured Viscosity of Friction Reducer (FR) Solution Based Upon A Commercially Avaible FR Chemical

| Exam | Notebook | | Description | NaCl | Shear Rate (1/s) ⁽*⁾ | | | |
|---|---|---|---|---|---|---|---|---|
| No. | ID | Description of Sample Recipes | of Conditions | (%) w/w | 105 | 210 | 525 | 1050 |
| 1 | 3-95-1 | Blend of 90 (g) of 3-93-1 (0.5% FR) + 210 (g) of water | 0.15FR Solution | 0 | 18.0 | 19.5 | 17.0 | 14.0 |
| 2 | 3-93-2 | Blend of 30% 3-93-1 (0.5% FR) + 2.0% of NaCl % | 0.15FR Solution | 2 | 0.0 | 0 | 5.8 | 6.0 |
| 3 | 3-94-1 | Blend of 90 (g) of 3-93-1 + 21 (gram) of NaCl + 189 (g) | 0.15FR Solution | 7 | 0.0 | 0 | 6.0 | 5.8 |
| | | of water | | | | | | |
| 4 | 3-94-2 | Blend of (90) (gram) of 3-93-1 + 42.0 (gram) of NaCl + | 0.15FR Solution | 14 | 0.0 | 0 | 6.0 | 6.8 |
| | | 168 (gram) of water | | | | | | |
| 5 | 3-94-3 | Blend of 90 (g) of 3-93-1 + 63.0 (gram) of NaCl + 147 | 0.15FR Solution | 21 | 0.0 | 1 | 7.0 | 7.7 |
| | | (gram) of Water | | | | | | |
| 6 | 3-113-1 | 0.5% FR Solution Viscosity | 0.5FR Solution | 0 | 527.0 | 343 | 191.0 | 100.0 |
| 7 | 3-114-1 | Blend of 0.5% FR (294 g) + 6.0 (g) of NaCl | 0.5FR Solution | 2 | 21.0 | 27.5 | 30.0 | 25.0 |
| 8 | 3-114-2 | Blend of 0.5% FR (285 g) + 15 (g) of NaCl | 0.5FR Solution | 5 | 1.0 | 12.5 | 23.0 | 19.7 |
| 9 | 3-114-3 | Blend of 0.5FR (276 gram) + 24 (g) | 0.5FR Solution | 8 | 21.0 | 22 | 23.0 | 19.0 |
| 10 | 3-115-1 | Blend of 0.5FR (258 (g) of water) + 42 (g) of NaCl | 0.5FR Solution | 14 | 22.0 | 23.5 | 22.8 | 19.6 |
| 11 | 3-115-2 | Blend of 0.5FR (240 g) of Water + 60 (gram) of NaCl | 0.5FR Solution | 20 | 28.0 | 26 | 25.0 | 21.8 |
| 12 | 3-115-3 | Blend of 0.5FR (225 gram) water + 75 (gram) of NaCl | 0.5FR Solution | 25 | 33.4 | 28 | 26.0 | 22.8 |

Note:
⁽*⁾ All samples were tested at an ambient temperature of 26.6° C.

Evidently, the viscosity was severely reduced from about 100 (cP) @1050 (SR (1/s) reduced to 19 (cP) or so for the 0.5% FR solution, similarly less depending upon the salt concentration until reached the salt saturated points of 25.0 or so under the ambient temperature of measurement. For the 0.15% FR solution, the added salt will dramatically reduce the viscosity of FR solution as close even at a low dose of salt concentration. The sodium chloride clearly discounts the viscosity of HPAM polymers as viscosifying agent. As a result, a solution is needed to resolve the low viscosity issue due to the added salts in the FR solution.

Example 13. To a 500 (mL) of glass beaker, 25.48 (gram) of 70 Crystal T Plus mineral oil, manufactured and distributed by STE, were charged, then, a magnetic stir bar was used to turn the mineral oil in vertex rotation mode. 2.998 (gram) of candle (paraffin) wax was charged and the mixed components were heated to 140° F. After the above two components were charged into the beaker and started to be heated up, 3.903 (gram) of Polysorbitan 60 MS NF and PEG 100 Glyceryl stearate acid ester, delivered by Amazon.com, was added into the beaker and continuously blended. The temperature of the mixed components was monitored with a laser gun that can determine the rotated fluid's temperature by laser beam. Once the mixed components reached 140° F., 1.499 (gram) of FTZ620, a hydrolyzed polyacrylate sodium acrylamide (HPAM) hydrogel polymer in powder, manufactured by a commercially available supplier, was charged into the beaker. The mixed components were blended for at least two to 5 minutes at 140 to 150° F. Then, 265.89 (gram) of water was added into the mixed components. The mixed temperature of final solution was 105° F. after the whole ingredients were added into the beaker. Then, the mixed components were reheated to a temperature of 140° F. above, then, cool down the whole mixture slowly until less than 108° F. Three batch's coating materials were prepared following the same recipe. The Brookfield viscosity of the mixed components was determined at an ambient temperature of 80° F. The sample was labelled as 3-72-1. It has a measured viscosity as follows: at shear rate of 105 (1/s): 833 (cPs); 210 (1/s): 593; 525 (1/s) 370; 1050 (1/s) 255.

Example 14: To a 500 (mL) of beaker, 297 (gram) of sample labelled with a notebook of ID:2-54-1 was charged. The sample of 2-54-1 contains a friction reducer concentration of 0.20% FR or 2.0 (gpt) and 2.0% NaCl solids in its solution. 3.0 (gram) of the developed additive solution labelled as the notebook ID: 3-72-1 was added into the rotated FR solution. The measured viscosity of the mixed FR solution was determined and listed in Table 2.

Example 15: To a 500 (mL) of beaker, 285 (gram) of sample labelled with a notebook of ID:2-54-1 was charged. The sample of 2-54-1 contains a friction reducer concentration of 0.20% FR or 2.0 (gpt) and 2.0% NaCl solids in its solution. 15.0 (gram) of the developed additive solution labelled as the notebook ID: 3-72-1 was added into the rotated FR solution. The measured viscosity of the mixed FR solution was determined and listed in Table 2.

Example 16: To a 500 (mL) of beaker, 270 (gram) of sample labelled with a notebook of ID:2-54-1 was charged. The sample of 2-54-1 contains a friction reducer concentration of 0.20% FR or 2.0 (gpt) and 2.0% NaCl solids in its solution. 30 (gram) of the developed additive solution labelled as the notebook ID: 3-72-1 was added into the rotated FR solution. The measured viscosity of the mixed FR solution was determined and listed in Table 2.

Example 17: To a 500 (mL) of beaker, 240 (gram) of sample labelled with a notebook of ID:2-54-1 was charged. The sample of 2-54-1 contains a friction reducer concentration of 0.20% FR or 2.0 (gpt) and 2.0% NaCl solids in its solution. 60 (gram) of the developed additive solution labelled as the notebook ID: 3-72-1 was added into the rotated FR solution. The measured viscosity of the mixed FR solution was determined and listed in Table 2.

Example 18: To a 500 (mL) of beaker, 225 (gram) of sample labelled with a notebook of ID:2-54-1 was charged. The sample of 2-54-1 contains a friction reducer concentration of 0.20% FR or 2.0 (gpt) and 2.0% NaCl solids in its solution. 75.0 (gram) of the developed additive solution labelled as the notebook ID: 3-72-1 was added into the rotated FR solution. The measured viscosity of the mixed FR solution was determined and listed in Table 2.

Example 19: To a 500 (mL) of beaker, 210 (gram) of sample labelled with a notebook of ID:2-54-1 was charged. The sample of 2-54-1 contains a friction reducer concentration of 0.20% FR or 2.0 (gpt) and 2.0% NaCl solids in its solution. 90 (gram) of the developed additive solution labelled as the notebook ID: 3-72-1 was added into the rotated FR solution. The measured viscosity of the mixed FR solution was determined and listed in Table 2.

Example 20: To a 500 (mL) of beaker, 195 (gram) of sample labelled with a notebook of ID:2-54-1 was charged. The sample of 2-54-1 contains a friction reducer concentration of 0.20% FR or 2.0 (gpt) and 2.0% NaCl solids in its solution. 105 (gram) of the developed additive solution labelled as the notebook ID: 3-72-1 was added into the rotated FR solution. The measured viscosity of the mixed FR solution was determined and listed in Table 2.

Example 21: To a 500 (mL) of beaker, 180 (gram) of sample labelled with a notebook of ID:2-54-1 was charged. The sample of 2-54-1 contains a friction reducer concentration of 0.20% FR or 2.0 (gpt) and 2.0% NaCl solids in its solution. 120 (gram) of the developed additive solution labelled as the notebook ID: 3-72-1 was added into the rotated FR solution. The measured viscosity of the mixed FR solution was determined and listed in Table 2.

Example 22: To a 500 (mL) of beaker, 150 (gram) of sample labelled with a notebook of ID:2-54-1 was charged. The sample of 2-54-1 contains a friction reducer concentration of 0.20% FR or 2.0 (gpt) and 2.0% NaCl solids in its solution. 150 (gram) of the developed additive solution labelled as the notebook ID: 3-72-1 was added into the rotated FR solution. The measured viscosity of the mixed FR solution was determined and listed in Table 2.

Example 23: To a 500 (mL) of beaker, 0 (gram) of sample labelled with a notebook of ID:2-54-1 was charged. The sample of 2-54-1 contains a friction reducer concentration of 0.20% FR or 2.0 (gpt) and 2.0% NaCl solids in its solution. 300 (gram) of the developed additive solution labelled as the notebook ID: 3-72-1 was added into the rotated FR solution. The measured viscosity of the mixed FR solution was determined and listed in Table 2.

Example 24: To a 500 (mL) of beaker, 195 (gram) of sample labelled with a notebook of ID:2-54-1 was charged. The sample of 2-54-1 contains a friction reducer concentration of 0.20% FR or 2.0 (gpt) and 2.0% NaCl solids in its solution. 105 (gram) of a friction reducer (FR) solution without any salts containing 0.5% FR by w/w solution was added into the rotated FR solution. The measured viscosity of the mixed FR solution was determined and listed in Table 2.

Example 25: To a 500 (mL) of beaker, 169 (gram) of sample labelled with a notebook of ID:2-54-1 was charged. The sample of 2-54-1 contains a friction reducer concentration of 0.20% FR or 2.0 (gpt) and 2.0% NaCl solids in its solution. 131 (gram) of a friction reducer (FR) solution without any salts containing 0.5% FR by w/w solution was added into the rotated FR solution. The measured viscosity of the mixed FR solution was determined and listed in Table 2.

Example 26: To a 500 (mL) of beaker, 160 (gram) of sample labelled with a notebook of ID:2-54-1 was charged. The sample of 2-54-1 contains a friction reducer concentration of 0.20% FR or 2.0 (gpt) and 2.0% NaCl solids in its solution. 140 (gram) of a friction reducer (FR) solution without any salts containing 0.5% FR by w/w solution was added into the rotated FR solution. The measured viscosity of the mixed FR solution was determined and listed in Table 2.

Example 27: To a 500 (mL) of beaker, 0 (gram) of sample labelled with a notebook of ID:2-54-1 was charged. The sample of 2-54-1 contains a friction reducer concentration of 0.20% FR or 2.0 (gpt) and 2.0% NaCl solids in its solution. 300 (gram) of a friction reducer (FR) solution without any salts containing 0.5% FR by w/w solution was added into the rotated FR solution. The measured viscosity of the mixed FR solution was determined and listed in Table 2.

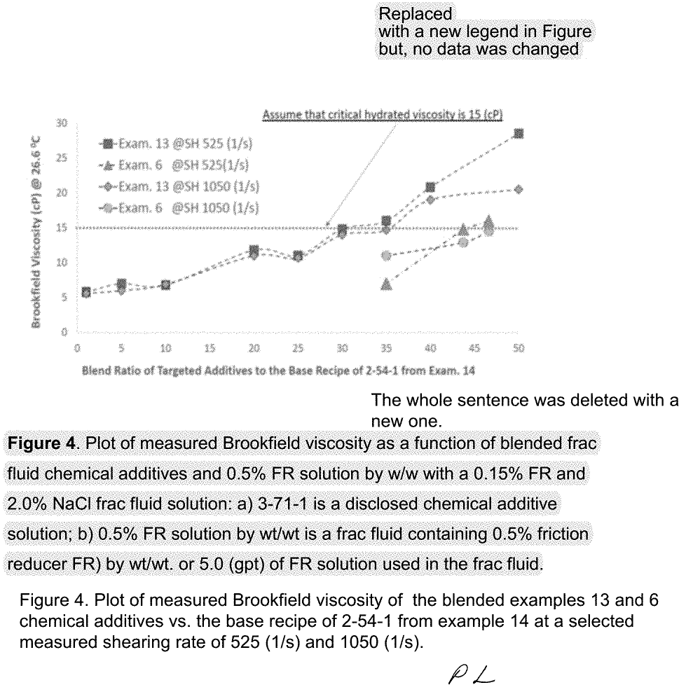

All data determined by Brookfield viscosity meter are listed in Table 2. A plot of viscosity of mixed components as function of blending ratio of disclosed recipe vs. 0.5% FR solution performance is shown in FIG. 4. Clearly, the disclosed recipe will out-perform the 0.5% FR solution. A 30% blend of disclosed recipe of 3-72-1 will have an equivalent performance as 0.5% FR blended with regular 0.20% FR and 2.0% NaCl solution together in a ratio of 50 to 50 by % wt. in term of measured viscosity. A critical hydrated viscosity of 14.0 (cP) can be set up in the experiment as a critical viscosity level.

In fact, it will be very possible for us to assume that the brine solution with 0.2% FR+2.0% NaCl solids in the solution is like what the produced water qualities. Potentially, 30% of developed additives could be applied to the product's application.

TABLE 2
Influence of Disclosed Recipes (3-72-1) vs. Regular 0.5% FR
Solution on the viscosity of 0.20% FR + 2.0% NaCl Solution

| | | | Component2 (g) | | | | | | |
|---|---|---|---|---|---|---|---|---|---|
| | | | Recipe ID: | | | | | | |
| | | Component1 (g) | 2-54-1 | | | | | | |
| Exam. | Sample | Recipe ID: | 0.2% FR 2.0% | Comp1/ | | Shear Rate (1/s) (*) | | | |
| No. | ID | 3-71-1 | NaCl Solution | Comp2 | Ratio | 105 | 210 | 525 | 1050 |
| 14 | 3-75-1 | 3 | 297 | 1/99 | 1 | 0 | 1 | 6 | 6 |
| 15 | 3-75-2 | 15 | 285 | 5/95 | 5 | 0 | 0 | 7 | 6 |
| 16 | 3-76-1 | 30 | 270 | 10/90 | 10 | 0 | 2 | 7 | 7 |
| 17 | 3-76-2 | 60 | 240 | 15/85 | 20 | 8 | 9 | 12 | 11 |
| 18 | 3-77-3 | 75 | 225 | 20/80 | 25 | 0 | 0 | 11 | 11 |
| 19 | 3-77-1 | 90 | 210 | 25/75 | 30 | 8 | 9 | 15 | 14 |
| 20 | 3-78-3 | 105 | 195 | 30/70 | 35 | 11 | 13 | 16 | 15 |
| 21 | 3-78-2 | 120 | 180 | 35/65 | 40 | 0 | 12 | 21 | 19 |
| 22 | 3-77-2 | 150 | 150 | 40/60 | 50 | 45 | 34 | 29 | 21 |
| 23 | 3-72-1 | 300 | 0 | 100/0 | 100 | 833 | 593 | 370 | 255 |
| | | 0.5% FR | 0.2% FR 2.0% | | | | | | |
| | | Soution | NaCl Solution | | | | | | |
| 24 | 3-81-1 | 105 | 195 | 35/65 | 35 | 2 | 2 | 7 | 11 |
| 25 | 3-83-1 | 131 | 169 | 43.73/56.27 | 44 | 13 | 11 | 15 | 13 |
| 26 | 3-82-1 | 140 | 160 | 46.6/64.4 | 47 | 12 | 15 | 16 | 15 |
| 27 | 3-113-1 | 300 | 0 | 100/0 | 100 | 527 | 343 | 181 | 100 |

Note:
(*) - All shearing test was measured at an ambient temperature of 26.06° C.

Example 28: To a 500 (mL) of beaker, charged a 25.628 (gram) of 70 T plus mineral oil, manufactured by STE, Inc. 1.499 (gram) of FTZ 620, a hydrolyzed acrylate sodium acrylate (HPAM) in powder, available from a commercial manufacturing, was charged into the beaker, then, 3.903 (gram) of polysorbitan 60 MS, NF, from Amazon.com, 0.228 (gram) of PEG 100 glyceryl stearate ester, mixed together, then, the magnetic stir and heater were turned on. As the mixed fluid temperature reached to 120° F., 2.998 (gram) of candle wax was added into the mixed components. The mixture's emulsion temperature was continuously increased until it reached to 140° F. or so, then, charged 266.0 (gram) of water into the mixed component. The temperature of mixed emulsion is reduced to 109° F. The above procedures were repeated, and two more batches materials were made and sealed in a plastic jar and ready for later use. The measured viscosity of the formulated coating at ambient temperature of 80° F. is as follows: @ shearing rate of 105 (1/s): 740 (cP); 210 (1/s): 510.0 (cP); 525 (1/s): 313 (cP); 1050 (1/s): 230 (cP). The sample was labelled as 3-86-1.

Example 29: To a 500 (mL) of beaker, charged 206 (gram) of water, then, 4 (gram) of NaCl solids, 90 (gram) of emulsion coating sample of 3-86-1 was blended with magnetic stir in the beaker, then, the viscosity of blended components was determined with Brookfield viscometer at an ambient temperature of 80° F. The results of the mixed component's viscosity are listed in Table 3.

Example 30: To a 500 (mL) of beaker, charged 196 (gram) of water, then, 14 (gram) of NaCl solids, 90 (gram) of emulsion coating sample of 3-86-1 was blended with magnetic stir in the beaker. Then, the viscosity of blended components was determined with Brookfield viscometer at an ambient temperature of 80° F. The results of the mixed component's viscosity are listed in Table 3.

Example 31: To a 500 (mL) of beaker, charged 176 (gram) of water, then, 34 (gram) of NaCl solids, 90 (gram) of emulsion coating sample of 3-86-1 was blended with magnetic stir in the beaker. Then, the viscosity of blended components was determined with Brookfield viscometer at an ambient temperature of 80° F. The results of the mixed component's viscosity are listed in Table 3.

Example 32: To a 500 (mL) of beaker, charged 167.0 (gram) of water, then, 43 (gram) of NaCl solids, 90 (gram) of emulsion coating sample of 3-86-1 was blended with a magnetic stir in the beaker. Then, the viscosity of blended components was determined with Brookfield viscometer at an ambient temperature of 80° F. The results of the mixed component's viscosity are listed in Table 3.

Example 33: To a 500 (mL) of beaker, charged 147.0 (gram) of water, then, 63 (gram) of NaCl solids, 90 (gram) of emulsion coating sample of 3-86-1 was blended with a magnetic stir in the beaker, then, the viscosity of blended components was determined with Brookfield viscometer at an ambient temperature of 80° F. The results of the mixed component's viscosity are listed in Table 3.

Example 34: To a 500 (mL) of beaker, charged 206.0 (gram) of water, then, 4 (gram) of NaCl solids, 90 (gram) of emulsion coating sample of 3-86-1 was blended with magnetic stir in the beaker, then, the mixed components were heated to a temperature of 150° F. The viscosity of blended components was determined with Brookfield viscometer at the targeted temperature of 150° F. The results of the mixed component's viscosity are listed in Table 3.

Example 35: To a 500 (mL) of beaker, charged 196.0 (gram) of water, then, 14.0 (gram) of NaCl solids, 90 (gram) of emulsion coating sample of 3-86-1 was blended with magnetic stir in the beaker, then, the mixed components were heated to a temperature of 150° F. The viscosity of blended components was determined with Brookfield viscometer at the targeted temperature of 150° F. The results of the mixed component's viscosity are listed in Table 3.

Example 36: To a 500 (mL) of beaker, charged 176.0 (gram) of water, then, 34 (gram) of NaCl solids, 90 (gram) of emulsion coating sample of 3-86-1 was blended with magnetic stir in the beaker, then, the mixed components were heated to a temperature of 150° F. The viscosity of blended components was determined with Brookfield viscometer at the targeted temperature of 150° F. The results of the mixed component's viscosity are listed in Table 3.

Example 37: To a 500 (mL) of beaker, charged 147.0 (gram) of water, then, 63 (gram) of NaCl solids, 90 (gram) of emulsion coating sample of 3-86-1 was blended with magnetic stir in the beaker, then, the mixed components were heated to a temperature of 150° F. The viscosity of blended components was determined with Brookfield viscometer at the targeted temperature of 150° F. The results of the mixed component's viscosity are listed in Table 3.

Example 38: To a 500 (mL) of beaker, charged 147.0 (gram) of water, then, 63 (gram) of NaCl solids, 90 (gram) of emulsion coating sample of 3-86-1 was blended with magnetic stir in the beaker, then, the mixed components were heated to a temperature of 150° F. The viscosity of blended components was determined with a Brookfield viscometer at the targeted temperature of 150° F. The results of the mixed component's viscosity are listed in Table 3.

Example 39: To a 1000 (gram) of beaker, 597.0 (gram) of water was charged into the beaker. 3.0 (gram) of LB206, a hydrolyzed polyacrylate sodium acrylamide (HPAM) polymer, commercially available from manufacturing, was drop wisely charged into the beaker with vertex rotation. The viscosity of the mixed components at ambient temperature of 80° F. as determined as follows: 424 (cP) @ shearing rates of 105 (1/s); 277 (cP) @ 210 (1/s); 157 (cP) @ 525 (1/s); 100 (cP) @1050 (1/s). The sample was labelled as 3-93-1.

Example 40: To a 500 (mL) of beaker, charged 204 (gram) of water, then, 6 (gram) of NaCl solids, 90 (gram) of 0.5% FR solution of 3-93-1 was blended with a magnetic stir in the beaker, then, the viscosity of blended components was determined with a Brookfield viscometer at the targeted temperature of 80° F. The results of the mixed component viscosity are listed in Table 3.

Example 41: To a 500 (mL) of beaker, charged 189 (gram) of water, then, 21 (gram) of NaCl solids, 90 (gram) of 0.5% FR solution of 3-93-1 was blended with magnetic stir in the beaker, then, the viscosity of blended components was determined with a Brookfield viscometer at the targeted temperature of 80° F. The results of the mixed component's viscosity are listed in Table 3.

Example 42: To a 500 (mL) of beaker, charged 168 (gram) of water, then, 42 (gram) of NaCl solids, 90 (gram) of 0.5% FR solution of 3-93-1 was blended with magnetic stir in the beaker, then, the viscosity of blended components was determined with a Brookfield viscometer at the targeted temperature of 80° F. The results of the mixed component's viscosity are listed in Table 3.

Example 43: To a 500 (mL) of beaker, charged 147 (gram) of water, then, 63 (gram) of NaCl solids, 90 (gram) of 0.5% FR solution of 3-93-1 was blended with magnetic stir in the beaker, then, the viscosity of blended components was determined with a Brookfield viscometer at the targeted temperature of 80° F. The results of the mixed component's viscosity are listed in Table 3.

Example 44: To a 500 (mL) of beaker, charged 210 (gram) of water, then, 0 (gram) of NaCl solids, 90 (gram) of 0.5% FR solution of 3-93-1 was blended with a magnetic stir in the beaker, then, the viscosity of blended components was determined with a Brookfield viscometer at the targeted temperature of 80° F. The results of the mixed component's viscosity are listed in Table 3.

All measured viscosity data of examples 29 to 44 are listed in Table 3. FIG. 3 demonstrates how the viscosity of disclosed recipe of 3-85-1 is in a response to the tested sample's temperature and salt concentration in comparison with the performance of 0.5FR % solution. Clearly, the disclosed recipe will be superior to a regular 0.5% FR solution in term of enhancing the viscosity of mixed components if 30% of coatings are incorporated into water or frac fluid.

TABLE 3
Measured Brookfield Viscosity with Selected Sample and Testing Conditions

| | | Blneded Component Wt (g) | | | | | | | | |
|---|---|---|---|---|---|---|---|---|---|---|
| Exam. | Sample | | NaCl | | Salt | Temperature | Shear Rate (1/s) | | | |
| No. | ID | ID: 3-86-1 | (Salt) | Water | % (w/w) | ° C. | 105 | 210 | 525 | 1050 |
| 29 | 3-87-1 | 90 | 4 | 206 | 1.33 | 26.70 | 0 | 0 | 9.8 | 9 |
| 30 | 3-88-1 | 90 | 14 | 196 | 4.67 | 26.70 | 0 | 3 | 9 | 8.6 |
| 31 | 3-88-2 | 90 | 34 | 176 | 11.33 | 26.7 | 0 | 0 | 10.8 | 10 |
| 32 | 3-89-1 | 90 | 43 | 166.6 | 14.47 | 26.70 | 0 | 0 | 12 | 10 |
| 33 | 3-89-2 | 90 | 63 | 147 | 21 | 26.7 | 16 | 14 | 13 | 12 |
| 34 | 3-87-1 | 90 | 4 | 206 | 1.33 | 65.6 | 0 | 0 | 6 | 5 |
| 35 | 3-88-1 | 90 | 14 | 196 | 4.67 | 65.6 | 0 | 0 | 6 | 5 |
| 36 | 3-88-2 | 90 | 34 | 176 | 11.33 | 65.6 | 0 | 0 | 5 | 5 |
| 37 | 3-89-1 | 90 | 43 | 166.6 | 14.47 | 65.6 | 0 | 0 | 5 | 5 |
| 38 | 3-89-2 | 90 | 63 | 147 | 21 | 65.6 | 0 | 0 | 5 | 6 |
| | | | NaCl | | | | | | | |
| | | 3-93-1 | (Salt) | water | | | | | | |
| 39 | 3-93-1 | 300 | 0 | 0 | 0 | 26.7 | 424 | 277 | 157 | 100 |
| 40 | 3-95-1 | 90 | 0 | 210 | 0 | 26.7 | 18 | 19.5 | 17 | 14 |
| 41 | 3-93-2 | 90 | 6 | 204 | 2 | 26.7 | 0 | 0.5 | 5 | 6 |
| 42 | 3-94-1 | 90 | 21 | 189 | 7 | 26.7 | 0 | 0 | 6 | 5.8 |
| 43 | 3-94-2 | 90 | 42 | 168 | 14 | 26.7 | 0 | 0 | 6 | 6.8 |
| 44 | 3-94-3 | 90 | 63 | 147 | 21 | 26.7 | 0 | 0 | 7 | 7 |

Example 45: To a 500 (mL) of beaker, 25.98 (gram) of 70 T Plus mineral oil was added, then, the mineral oil was stirred with a magnetic stir bar, 1.93 (gram) of soy protein isolate (SPI) and 2.57 (gram) of p-MDI solution (50% concentration) was added into the beaker, the mixed components were heated to the temperature of 140° F. or above. Then, FTZ620 and sweet rice flour were pre-blended together and charged into the beaker. At 150° F., (6)+(7) were charged into the beaker. Let the mixed components heated in the beaker for 5 (minutes), then, water (8) was charged into the beaker. The fluid temperature of the mixed solution had a temperature of 108° F. The mixed components were continuously heated to 140° F. to make sure that all of components are fully dispersed and mingled together. Finally, the mixed components were cooled down while stirring the whole mixture to get a homogeneous and dispersive emulsion of solution. Table 4 summarizes the recipe components and procedure for the preparation of the coated emulsion.

TABLE 4
Multifunctional Chemical Additive
Recipes (Notebook ID: 3-117-1)

| | | Quantities | Wt % |
|---|---|---|---|
| Item | Components | (g) | (w/w) |
| 1 | 70 T MinerAL Oil | 25.98 | 6.494 |
| 2 | Soy Protein Isolate | 1.93 | 0.482 |
| 3 | Oil Based p-MDI Solution | 2.57 | 0.642 |
| | (50% Conc.) | | |
| 4 | FTZ620 | 1.60 | 0.400 |
| 5 | Sweet Rice | 0.80 | 0.200 |
| 6 | Polysorbitan 60 MS NF | 4.18 | 1.045 |
| 7 | PEG100 Glyceryl Stearate | 0.25 | 0.063 |
| 8 | Water | 362.70 | 90.675 |
| | Sub Total: | 400.00 | 100.00 |
| | Key Ingredient (%): | | 9.33 |
| | Total Solid %: | | 2.51 |

### Procedures:

1) To a 500 (mL) beaker, charged (1)+(2)+(3) and stir the mixed components under magnetic bar
2) After the temperature of the mixed components reach 140° F., charge components (4)+(5)
3) Continuously increase the temperature to 150° F. or above until 169° F.
4) Charge (6)+(7) and blend for at least 5 (minutes) before charging final water (keep the solution temperature above 150° F. or above for high reaction rate)
5) charged (8) and measure the mixed temperature at 108° F.
6) Increase the temperature to 140° F. again.
7) Cool down the mixture slowly while stirring
8) Continuously cool down until room temperature at 80° F.
9) Pour the materials into the container and measure its viscosity and other physical parameters

The measured viscosity of the sample from example 45 at an ambient temperature of 80° F. is as follows: 215 (cP) @ shearing rates of 105 (1/s); 181 (cP) @ 210 (1/s); 147 (cP) @ 525 (1/s); 100 (cP) @ 1050 (1/s).

Example 46: To a 500 (mL) beaker, 90.0 (gram) of the emulsion from example 45 was charged, then, 75.0 (gram) of Morton Salts and 135 (gram) were added into the beaker under a magnetic stir bar. The measured viscosity of the sample from the blended sample at the ambient temperature of 80° F. was as follows: 20 (cP) @ shear rates of 105 (1/s); 16.0 (cP) @ shearing rate of 210 (1/s), 14.0 (cP) @ 525 (1/s), 12.0 (cP) @ 1050 (1/s).

Example 47: The sample of example 46 was heated to 150° F., then, the viscosity of the mixed fluid was measured at 150° F. having the following viscosity measurement results: 6.8 (cP) @ shear rate of 525 (1/s) and 6.0 @ 1050 (1/s).

Example 48: To the 500 (mL) beaker, 75 (gram) of Morton salts was added, then, the emulsion prepared from example 45 was charged until 225 (gram) of Morton salts was charged and blended with a magnetic stir bar. The measured viscosity of mixed components at the ambient temperature of 80° F. is as follows: 128.0 (cP) at a shear rate of 105 (1/s); 83.5 (cP) @ 210 (1/s), 71.0 (cP) @525 (1/s); 58.0 (cP) @1050 (1/s).

Example 49: The 300 (gram) sample of example 48 was heated to 150° F. The measured Brookfield viscosity of the heated sample is as follows: 21.0 (cP) @ the shear rate of 105 (1/s); 20.0 (cP) @ the shear rate of 210 (1/s); 17.0 (cP) @ the shear rate of 525 (1/s); 16.7 (cP) @ 1050.

The results of the measured viscosity data from examples 45 to 49 demonstrate that different from the hydrolyzed polyacrylate sodium acrylamide (HPAM) polymers, the performance of the emulsion prepared by the disclosed recipe of example 45 shows an excellent tolerance to the high salinity of the tested fluid. The disclosed products are potential candidates as saturated salty frack fluid with the downhole processing temperature as high as 150° F. or so. Potentially, the reacted soy protein isolate (SPI) with the p-MDI isocyanate plays a crucial role in enhancing the salt tolerance and temperature resistance of acrylate sodium acrylamide polymers to the loss of viscosity of tested fracking fluid.

TABLE 5
A Summary of Mixed Component Formula and
Procedures for Preparing the formula

| | | Quantities | |
|---|---|---|---|
| Item | Components | (g) | Wt % |
| 1 | 70 T MinerAL Oil | 27.26 | 6.815 |
| 2 | Candle Wax | 3.21 | 0.802 |
| 3 | Polysorbitan 60 MS NF | 4.18 | 1.045 |
| 4 | PEG100 Glyceryl Stearate | 0.25 | 0.062 |
| 5 | FTZ620 | 1.6 | 0.401 |
| 6 | Sweet Rice | 0.8 | 0.2 |
| 7 | Water | 362.7 | 90.676 |
| | | 400 | 100.00 |
| | Key Ingredient: | | 9.325 |
| | Solid % by w/w: | | 2.51 |

### Procedures:

1) Pre-blend (5)+(6) together
2) charge (1) in a 500 (mL) of beaker and stir the mixed components in charged beaker
3) Add (2), then, heat the mixed component to 140° F. or above to allow the wax component totally dissolved.
4) charge (4)+(5) mixture into the beaker and stirred for another 5.0 (minutes)
5) Add cooling water,
6) Continuously heat the whole mixed components until to 150° F.
7) turn off the heater and allow enough time for the mixed components settle.

Example 50: 1.60 (gram) of FTZ620 and 0.80 (gram) of sweet rice flour in powder were pre-blended. Then, to a 500 (mL) of beaker, 27.26 (gram) of 70 T Plus mineral oil was charged, then, a magnetic stir bar was used to disperse the mineral oil. 3.21 (gram) of candle wax with heater turn on. At the temperature of 168° F., charged (5)+(6) mixed components. At the temperature of 167 OF, charged water (7). The temperature of the mixed components drops to 108° F. Re-heated the mixed components back to 150° F. before the fluid temperature of the whole mixed components were reduced to room temperature. The measured Brookfield viscosity at the ambient temperature of 80° F. is as follows: 575 (cP) @ a shear rates of 105 (1/s); 245 (cP) @ 397.5 (cP) @ 210 (1/s); 245 (cP) @525 (1/s); 168.5 (cP) @1050 (1/s).

Example 51: To the 500 (mL) of beaker, 90.0 (gram) of emulsion prepared with the recipes and procedures described in example 50 was charged with magnetic stir turned on. Then, 210.0 (gram) of water was charged into the beaker. The viscosity of the mixed sample was measured with Brookfield viscosity. The testing result is summarized in table 6.

Example 52: To the 500 (mL) of beaker, 90.0 (gram) of emulsion prepared with the recipes and procedures described in example 50 was charged with magnetic stir turned on. Then, 6.0 (gram) of Morton salts were charged into the beaker, 204.0 (gram) of water was also charged into the beaker. The viscosity of the mixed sample was measured with Brookfield viscosity at an ambient temperature of 80° F. (26.7° C.). The testing result is listed in table 6.

Example 53: To the 500 (mL) of beaker, 90.0 (gram) of emulsion prepared with the recipes and procedures described in example 50 was charged with magnetic stir turned on. Then, 15.0 (gram) of Morton salts were charged into the beaker, 195.0 (gram) of water was also charged into the beaker. The viscosity of the mixed sample was measured with Brookfield viscosity at an ambient temperature of 80° F. (26.7° C.). The testing result is listed in Table 6.

Example 54: To the 500 (mL) of beaker, 90.0 (gram) of emulsion prepared with the recipes and procedures described in example 50 was charged with magnetic stir turned on, then, 24.0 (gram) of Morton salts were charged into the beaker, 186.0 (gram) of water was also charged into the beaker. The viscosity of the mixed sample was measured with Brookfield viscosity at an ambient temperature of 80° F. (26.7° C.). The testing result is listed in Table 6.

Example 55: To the 500 (mL) of beaker, 90.0 (gram) of emulsion prepared with the recipes and procedures described in example 50 was charged with magnetic stir turned on, then, 42.0 (gram) of Morton salts were charged into the beaker, 168.0 (gram) of water was also charged into the beaker. The viscosity of the mixed sample was measured with Brookfield viscosity at an ambient temperature of 80° F. (26.7° C.). The testing result is listed in table 6.

Example 56: To the 500 (mL) of beaker, 90.0 (gram) of emulsion prepared with the recipes and procedures described in example 50 was charged with magnetic stir turned on, then, 60.0 (gram) of Morton salts were charged into the beaker, 150.0 (gram) of water was also charged into the beaker. The viscosity of the mixed sample was measured with Brookfield viscosity at an ambient temperature of 80° F. (26.7° C.). The testing result is listed in table 6.

Example 57: To the 500 (mL) of beaker, 90.0 (gram) of emulsion prepared with the recipes and procedures described in example 50 was charged with magnetic stir turned on, then, 75.0 (gram) of Morton salts were charged into the beaker, 135.0 (gram) of water was also charged into the beaker. The viscosity of the mixed sample was measured with Brookfield viscosity at an ambient temperature of 80° F. (26.7° C.). The testing result is listed in table 6.

Example 58: 300 (gram) of the blended sample from the example 51 was heated to 150° F. The viscosity of the sample was determined at 150° F. The result was summarized in Table 6.

Example 59: 300 (gram) of the blended sample from the example 52 was heated to 150° F. The viscosity of the sample was determined at 150° F. The result was summarized in Table 6.

Example 60: 300 (gram) of the blended sample from the example 53 was heated to 150° F. The viscosity of the mixed sample was determined at 150° F. The result was summarized in Table 6.

Example 61: 300 (gram) of the blended sample from the example 54 was heated to 150° F. The viscosity of the mixed sample was determined at 150° F. The result was summarized in Table 6.

Example 62: 300 (gram) of the blended sample from the example 55 was heated to 150° F. The viscosity of the mixed sample was determined at 150° F. The result was summarized in Table 6.

Example 63: 300 (gram) of the blended sample from the example 56 was heated to 150° F. The viscosity of the mixed sample was determined at 150° F. The result was summarized in Table 6.

Example 64: 300 (gram) of the blended sample from the example 57 was heated to 150° F. The viscosity of the mixed sample was determined at 150° F. The result was summarized in Table 6.

TABLE 6
Blend of 3-100-1 with water at different sodium chloride solid concentration
at a ratio of 30% 3-100-1 with different concentrated NaCl Solution

| | | | | | | | Viscosity (cP) | | | |
|---|---|---|---|---|---|---|---|---|---|---|
| | | Blended FR | | | | | Spindle Rotation Speed (RPM) | | | |
| | | Solution Weight | | | Solution | Salt | 6 | 12 | 30 | 60 |
| Exam. | Sample | ID: 3-100-1 | Salt | Water | Temperature | Concentration | SR(105 | SR(210 | SR(525 | SR(1050 |
| No | ID | (g) | (g) | (g) | ° C. | (%) | 1/s) | 1/s) | 1/s) | 1/s) |
| 51 | 3-104-1 | 90 | 0 | 210 | 26.7 | 0.0 | 0 | 0 | 21 | 18 |
| 52 | 3-105-1 | 90 | 6 | 204 | 26.7 | 2 | 0 | 0 | 9.8 | 8.6 |
| 53 | 3-105-2 | 90 | 15 | 195 | 26.7 | 5 | 0 | 0 | 5.2 | 9.2 |
| 54 | 3-105-3 | 90 | 24 | 186 | 26.7 | 8 | 12 | 10 | 11 | 9.5 |
| 55 | 3-106-1 | 90 | 42 | 168 | 26.7 | 14 | 16 | 14.5 | 11.8 | 10 |
| 56 | 3-106-2 | 90 | 60 | 150 | 26.7 | 20 | 37 | 27.5 | 21.8 | 16 |
| 57 | 3-106-3 | 90 | 75 | 135 | 26.7 | 25 | 72 | 51 | 34 | 24 |
| 58 | 3-108-3 | 90 | 0 | 210 | 65.6 | 0 | 0 | 0 | 7 | 7.6 |
| 59 | 3-108-4 | 90 | 6 | 204 | 65.6 | 2 | 0 | 0 | 5 | 4.5 |
| 60 | 3-109-1 | 90 | 6 | 195 | 65.6 | 5 | 0 | 0 | 5 | 4.6 |
| 61 | 3-108-2 | 90 | 24 | 186 | 65.6 | 8 | 0 | 0 | 4 | 4.8 |
| 62 | 3-108-1 | 90 | 42 | 168 | 65.6 | 14 | 0 | 0 | 6 | 5 |
| 63 | 3-106-2 | 90 | 60 | 150 | 65.6 | 20 | 0 | 0 | 5.6 | 5.7 |
| 64 | 3-107-1 | 90 | 75 | 210 | 65.6 | 25 | 0 | 0 | 5.8 | 5 |

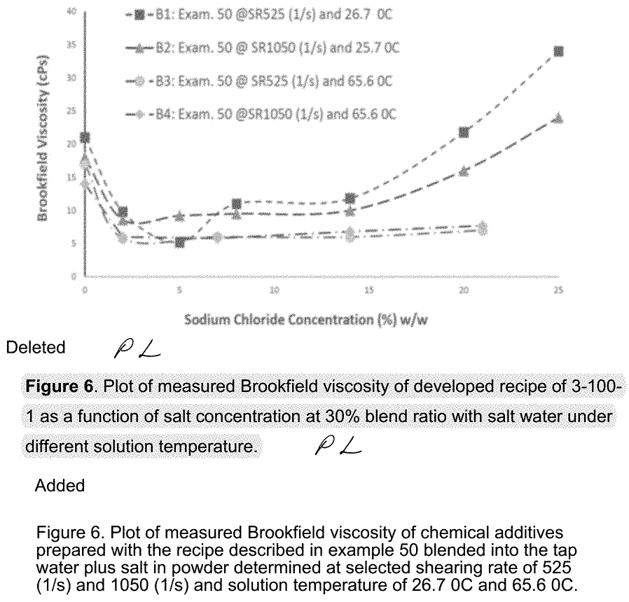

Shown in FIG. 6 based upon the measured data from examples 51 to 64 listed in table 6, a blend of 30% by w/w of disclosed recipe of example 51 with different salt concentration presents different viscosity profile of the products from the regular 0.5% FR solution profile as shown in FIG. 1. For high shear rate of 1050 (1/s), the viscosity of the samples shows significant reduction as salt concentration is less than 5%. Then, between 5.0% to 15.0%, the viscosity shows a flatten pattern of viscosity vs. salinity, however, as the salt % increases from 15.0% to 25.0% w/w, the viscosity of the fluid products increases proportionally. The curvature of viscosity vs. salt percentage in this case is a bath tube pattern. In contrast, for regular FR such as HPAM, the curvature profile of viscosity vs. salt concentration for regular FR solution is in a L shape. Once sodium chloride is added into the FR solution. The viscosity of the mixed FR solution will have a dramatic drop of its viscosity due to the sensitivity of the salt to the frac fluid. Clearly, the disclosed recipe overcome the drawback of traditional HPAM anionic polymers in the application of cases of high salinity operation range.

Example 65: To a 1000 (mL) of the beaker, charged 38.96 (gram) of 70 T Mineral oil, 2.89 (gram) of soy protein isolate, 3.85 (gram) of p-MDI solution, 2.40 (gram) of FTZ 620, a commercially available polyacrylate sodium acrylamide polymer, together, then, stir the mixed components. The temperature of the mixed components was increased to 176° F., charged 1.2 (gram) of sweet rice in powder, 6.17 (gram) of polysorbitan 60 MS NF and 0.38 (gram) of PEG100 glyceryl stearate were also charged in sequence. Then, 544.05 (gram) of water was charged following the procedures listed in Table 7.

TABLE 7
Summary of the Multicomponent Recipes for High
Salt Tolerant Frac Fluid (Notebook ID: 3-126-1)

| | | Quantities | | Extended Wt. |
|---|---|---|---|---|
| Item | Components | (g) | Wt % | (g) |
| 1 | 70 T MinerAL Oil | 25.976 | 6.494 | 38.96 |
| 2 | Soy Protein Isolate | 1.926 | 0.482 | 2.89 |
| 3 | Oil Based p-MDI Solution | 2.568 | 0.642 | 3.85 |
| | (50% Conc.) | | | |
| 4 | FTZ620 | 1.6 | 0.400 | 2.40 |
| 5 | Sweet Rice | 0.8 | 0.200 | 1.20 |
| 6 | Polysorbitan 60 MS NF | 4.18 | 1.045 | 6.27 |
| 7 | PEG100 Glyceryl Stearate | 0.25 | 0.063 | 0.38 |
| 8 | Water | 362.7 | 90.675 | 544.05 |
| | Sub Total: | 400 | 100.000 | 600.00 |

### Procedures:

1) To a 1000 (mL) beaker, charge (1)+(2)+(3)+(4) and stir the mixed components under magnetic bar
2) After the temperature of the mixed components reached 140° F., charge components (5)
3) Continuously increase the temperature to 150° F. or above
4) Charge (6)+(7) and blend for at least 5 (minutes) before charging final water (keep the solution temperature above 150 OF or above)
5) Cool down the mixture and reduce the temperature to ambient temperature

At an ambient temperature of 80 OF, the viscosity of the blended components with a Brookfield viscometer was determined as follows: 164 (cP) at shear rate of 105 (1/s); 150 (cP) at 210 (1/s); 116 (cP) 525 (1/s); 88 (cP) 1050 (1/s).

Example 66: To a 1000 (mL) of the beaker, 75 (gram) of Morton Salt (NaCl) solids was charged, then, 225 (gram) of the example 65 sample with stirred. The viscosity of the mixed components at an ambient temperature of 80° F. was determined as follows: 33 (cP) at a shearing rate of 105 (1/s); 34 (cP) at 210 (1/s); 34 (cP) at 525 (1/s); 31 (cP) 1050 (1/s).

Example 67: The mixed sample from example 66 was stirred in the beaker meanwhile was heated to 160° F. The viscosity of the sample at 160° F. was determined as follows: 12 (cP) at a shearing rate of 105 (1/s); 9.5 (cP) 210 (1/s); 13 (cP) 525 (1/s); 12 (cP) 1050 (1/s).

Example 68: The mixed sample from example 67 was stirred in the beaker meanwhile was heated to 180° F. The viscosity of the sample at 180° F. was determined as follows: 7 (cP) at a shearing rate of 105 (1/s); 7.5 (cP) 210 (1/s); 10 (cP) 525 (1/s); 10 (cP) 1050 (1/s).

Example 69: To a 1000 (mL) of the beaker, 24 (gram) of Morton Salt (NaCl) solids was charged, then, 276 (gram) of the example 65 sample with stirred. The viscosity of the mixed components at an ambient temperature of 80° F. was determined as follows: 16 (cP) at a shearing rate of 105 (1/s); 28 (cP) at 210 (1/s); 34 (cP) at 525 (1/s); 31 (cP) 1050 (1/s).

Example 70: The mixed sample from example 66 was stirred in the beaker meanwhile was heated to 160° F. The viscosity of the sample at 160° F. was determined as follows: 7.5 (cP) at a shearing rate of 105 (1/s); 7.5 (cP) 210 (1/s); 12.0 (cP) 525 (1/s); 11.0 (cP) 1050 (1/s).

TABLE 8
Rheological Characterization of Formulated
Resin Coating Sample (Notebook ID: 3-126-1)

| | Solution | Additive | | Salt | Brookfield | | | |
|---|---|---|---|---|---|---|---|---|
| | Tempeature | ID: 3-126-1 | Salt | % w/w | Viscosity (cPs) | | | |
| Item ID | ° F. | (g) | (g) | % | 105 | 210 | 525 | 1050 |
| Exam. 65 | 80 | 300 | 0 | 0 | 164 | 150 | 116 | 88 |
| Exam. 66 | 80 | 225 | 75 | 25 | 33 | 34 | 34 | 31 |
| Exam. 67 | 160 | 225 | 75 | 25 | 12 | 9.5 | 13 | 12 |
| Exam. 68 | 180 | 225 | 75 | 25 | 7 | 7.5 | 10 | 10 |
| Exam. 69 | 80 | 276 | 24 | 8 | 16 | 28 | 34 | 31 |
| Exam. 70 | 160 | 276 | 24 | 8 | 7.5 | 7.5 | 12 | 11 |

The recipe of example 65 has an excellent salt tolerance and is a preferred candidate recipe as the high salt tolerance friction reducer. The rheological values show that high percentages of salts significantly reduce the viscosity of the tested samples. As the solution temperature was above 160° F., the measured viscosity of mixed solution reduced to 10 (cPs) (example 69) at a shearing rate of 1050 (1/s) at a salt solution of 25.0%. Evidently, the final copolymer of soy protein isolate (SPI) with isocyanate polymer makes positive contribution to the enhanced viscosity of frac fluid additives and multifunctional coating recipes.

Example 71 To a 1000 (mL) of the beaker, charged 38.956 (gram) of 70 T Mineral oil, 2.89 (gram) of soy protein isolate, 4.53 (gram) of p-MDI solution, 2.40 (gram) of FTZ 620, then, stir the mixture and heated to 150° F., a commercially available polyacrylate sodium acrylamide polymer and 1.20 (gram) of sweet rice flour were charged at the temperature of 140° F. Then, 6.27 (gram) of polysorbitan 60 MS NF and 0.38 (gram) of PEG100 glyceryl stearate were also charged in sequence. Then, 544.05 (gram) of water. Finally, 0.489 (gram) of copper sulfate solution (Concentration: 12.0%) was charged, following the procedures listed in Table 9.

TABLE 9
Emulsion Coating Recipe containing Antimicrobial Component

| | | Quantities | |
|---|---|---|---|
| Item | Components | (g) | % Wt |
| 1 | 70 T MinerAL Oil | 38.956 | 6.480 |
| 2 | Soy Protein Isolate | 2.89 | 0.481 |
| 3 | p-MDI isocyanate (Oil based Isocyanate) | 4.53 | 0.754 |
| 4 | FTZ620 | 2.4 | 0.399 |
| 5 | Sweet Rice | 1.2 | 0.200 |
| 6 | Polysorbitan 60 MS NF | 6.27 | 1.043 |
| 7 | PEG100 Glyceryl Stearate | 0.38 | 0.063 |
| 8 | Water | 544.05 | 90.499 |
| 9 | Copper sulfate solution (Conc.: 12.0%) | 0.489 | 0.081 |
| | Total: | 601.165 | 100.00 |

1) To a 1000 (mL) beaker, charge (1)+(2)+(3) and stir the mixed components under magnetic bar
2) After the temperature of the mixed components reached 140 OF, charge components (4)+(5)
3) Continuously increase the temperature until at 150° F.
4) Charge (6)+(7) and blend for at least 5 (minutes) for at 3-5 (minutes)
5) charge (8) and then, increase the mixed component temperature to 150° F. before cooling down.
6) Cool down the mixture and reduce the temperature to ambient temperature
7) Charge the (9) after the mixture cool down and continuously blend for 30 minutes before packing.

The final emulsion was labelled as 3-140-1. Brookfield viscosity was measured on the products as follows: 184.0 (cps) at a shear rate of 105 (1/s); 164.5 (Cp) at 210 (1/s); 122.0 (cP) at 525 (1/s); 96.0 (cPs) at 1050 (1/s).

Based upon the disclosure present here, it is therefore demonstrated that the objectives of the present inventions are accomplished by the chemical components and additive combination with special procedures and compositions of matters, and preparation of methods, its applications and identified benefits for the hydraulic fracking operation in oil and gas industries disclosed herein, it showed to be understood that the selection of the specified lubricant, SPI and wax as hydrophobic domains, emulsifiers, hydrogel polymers, and poly-sugar extenders, and cross-linking agents, and make-up water by wt. percentage can be determined by one having ordinary skill in the art without departing from the spirit of the invention herein disclosed and described. It should be therefore be appreciated that the present invention is not limited to the specific embodiments described above, but includes variation, modification, and equivalent embodiments defined by the following claims.

### CITED REFERENCE

Rodriguez L., S. Antignard, B. Giovannetti, G. Dupuis, and N. Gaillard, S. Jouenne, G. Bourdarot, and D. Morel, A. Zeitoun, and B. Grassl, 2019, A new thermally stable synthetic polymer for harsh conditions of middle east reservoirs. AAPG/SPE Middle East Region RDPETRO.
Sarkis, K. R., K. J. Roberto, U.S. Patent Application 20170198206, Jul. 13, 2017.
Nguyen, T. C., B. Roman, E. Vinson, H. Wiggins, 2018, Effects of salt on the performance of drag reducers in slick water fracturing fluids. J. of Petroleum Science & Engineering volume 163, April 2018, pages 590-599.
Li, x., H. Y. Yin, R. S. Zhang, 2019, a salt-induced viscosifying smart polymer for fracturing inter-salt shale oil reservoirs. Petroleum Science, 16:816-829.
Soybeans and Soybean Products eds. By K. S. Markley, Inter-science Publishers Inc. 1950 (Volume I) and 1951 (Volume II).
Nishinari, K, Y. Fag, S. Guo, G. O. Philips, 2014, Soy proteins: A review on composition, aggregation, and emulsification, Food Hydrocolloids, 39: 301-318.
Parker, A. A. US Patent Application, 20100310877, Protein-containing emulsions and adhesives, manufacturing and use thereof.

The invention claimed is:

1) A chemical additive component by percentage weight comprising of:
a) Hydrophobic/hydrophilic or/and hydro-dual-phobic domains ranged in 0.10% to 10.0%;
b) lubricant as a hydrophobic solvent: 0.1% to 50.0%;
c) hydrogel polymers: 0.0% to 35.0%;
d) emulsifier/surfactants: 0.1% to 20.0%;
e) fresh water or produced water: 40% to 99.0%.
f) a combination of (a)+(b)+(c)+(d) for enhancing the viscosity of frac fluid in a high salinity brine originated from fresh water or/and produced water with reduced pumping pressure in a salinity concentration range from 0.01% to saturated concentration of 26.5% or so at ambient temperature and downhole fluid temperature as high as 200° F.

2) The chemical additive component of claim 1 wherein hydrophobic/hydrophilic domain-hydro-dual-phobic domain materials can be organic polymers or bio-derivatives made of petroleum paraffin or/and soy protein isolate (SPI), soy protein concentrates (70% protein), soy flour, or denatured soy protein, preferred 90-95% SPI, modified SPI and hydrogel polymers, and its derivatives, or their combination that can be mixed with fresh, produced water or their blends with friction reducers. The dosage level of these domains materials is ranged from 0.01% to 10.0% by percentage weight.

3) The chemical additive component of claim 1 wherein the lubricant or/and nonpolar solvent is mineral oil, saturated hydrocarbon, alkyl chains of ethylene carbon, liquid paraffin, kerosene, petroleum distillates; and high alkanes, cyclo-alkanes, the alkyl/carbon chain from C6 to C20. The dosage level of these chemicals is ranged from 0.10% to 50.0% by percentage weight.

4) The chemical component of claim 1 wherein the hydrogel polymer as hydrophilic/hydrophobic domains and as suspending agent are hydrated polymers, including polyacrylate anionic polymers; or cationic or nonionic polymers or hydrolyzed acrylate sodium acrylamide polymers, the combination of these polymers and their copolymers functionalized with functional groups of amine, hydroxyl, and carboxyl, and aldehyde sulfonate, and cyclic amine and vinyl functional groups, having linear, or/and 3-dimensional network. The dosage level is ranged from 0.0% to 35.0%, preferred less than 10.0%, more preferred less than 5.0% by percentage weight.

5) The chemical components of claim 1 wherein the water consisting of the fresh water and produced water that originated from reuse and recycled water from flowback of oil and gas wells during and after fracking operation, containing cationic ions such as sodium chloride, calcium chloride, magnesium chloride, and ferric chloride, and other ions. The dosage level of these types of water is ranged from 60.0% to 99.0%, preferred 85.0%, 90.0%, 95.0%, 97.0% more.

6) The chemical component additives of claim 2 wherein soy protein isolate can be applied as individual components or cross-lined and surface modified with isocyanate resin or epoxy oxide reactive polymers using the mineral oil or other lubricant chemicals as solvent media, isocyanate resin is ranged within a ratio of 0.1% to 200% to the SPI by % (wt.).

7) The chemical component additives of claim 6 wherein the sweet rice flour is copolymerized with soy protein of claim 6 by a crosslinking reaction through isocyanate within a reaction ratio of sweet rice flour to soy protein from 20/90 to 0/100.

8) The chemical additives of claim 6 wherein the added soy protein isolate and other components such as wax and sweet rice flour as hydro-dual-phobic domains materials is ranged from 0.01% to 15. % (wt./wt.) of the total wt. of the claim 1.

9) The chemical additives of 1 wherein the emulsifiers are comprising of polyanionic polymers, cationic polymers, nonionic surfactants and polymeric materials, ranged from 0.01% to 20.0%, more preferred less than 5.0% by percentage weight.

10) The chemical additives of claim 1 wherein it is prepared by charging the lubricant or/and nonpolar solvent in a tanker, followed by blending SPI, wax, and sweet rice flour, or modifying the surface of SPI, sweet rice flour, or copolymerizing the SPI with hydrogel polymers such as polyacrylate sodium acrylamide polymer together.

11) The chemical additives of claim 10 wherein the mixed components temperature should be raised to a temperature that can partially dissolve desirable components, the preferred reaction temperature of the mixed components is 140° F. or above.

12) The formation of the additives of claim 10 wherein the emulsifiers and surfactant components can be incorporated after the components of SPI isocyanate and sweet rice flour get fully mixed and reacted together. The emulsifiers should be added after SPI and rice flour are fully reacted with cross-linking agent. Alternatively, the SPI and rice flour and emulsifiers can be mixed simultaneously using mineral oil as solvent.

13) The chemical additives of claim 12 wherein the fresh water or produced water is charged into the recipes and the blended components were cooled down in the tanker while stirred with a colloid emulsion.

14) The chemical additives of claim 13 wherein it can be used as viscosity enhancing agent to blend itself with regular Friction reducer solution at a ratio of 30:70 to 100:0, preferred below 55% of claim 13 chemical additives.

15) The chemical additives of claim 13 wherein the formulated components can be blended into salinity brine solution with salt concentration from 0 to 26.5% at an ambient temperature.

16) The chemical additives of claim 14 or/and 15 wherein the generated components can be used in hydraulic fracking operation dealing with high temperature with enhanced viscosity of frac fluid application with the well downhole temperature from 80 to 250° F., more preferred less than 200° F.

17) The chemical additives of claim 10 wherein preservative additives organic or inorganic, in granular or solutions, such as hexamine, glutaraldehyde, formaldehyde, phenoxyethanol, copper sulfate, methylisothiazolinone, benzyl acid, benzyl acid ester, fatty amine surfactants, etc., functionalized as antimicrobial agents to bi-derivative polymers such as SPI and sweet rice flour, can be pre- or/and post added into the chemical additives of claim 12, ranged from within 0.00001% to 1.0% to the total % (wt.) of chemical additives of claim 1.

18) The chemical additives of claim 17 wherein the blended components are useful as viscosity adjusting agent to have the frac fluid product's hydrate viscosity ranged from 5000 (cps) to 5 (cp), preferred less than 500 (cps), 100 (cps), 20 (cps), 10 (cps).
